(19) United States
(12) Patent Application Publication
(10) Pub. No.: US 2025/0322786 A1
(43) Pub. Date: Oct. 16, 2025

(54) DISPLAY PANEL AND DRIVING METHOD THEREOF, AND DISPLAY DEVICE

(71) Applicant: XIAMEN TIANMA DISPLAY TECHNOLOGY CO., LTD., Xiamen (CN)

(72) Inventors: Yuheng ZHANG, Xiamen (CN); Jiemiao PAN, Xiamen (CN)

(21) Appl. No.: 19/249,054

(22) Filed: Jun. 25, 2025

(30) Foreign Application Priority Data
Dec. 24, 2024 (CN) 202411918673.5

(51) Int. Cl. G09G 3/32; G09G 3/20

(52) U.S. Cl. CPC G09G 3/32; G09G 3/2007; G09G 2300/0842; G09G 2300/0861; G09G 2310/08; G09G 2320/0247; G09G 2330/021

(57) ABSTRACT

Provided are a display panel and a driving method thereof, and a display device The display panel includes: a pixel circuit, including a driving module and a bias adjustment module having a control terminal connected to a first scan line for providing a first scanning signal, and a first terminal connected to a bias signal line for providing a bias voltage. the display panel has a first frequency, a driving cycle at the first frequency includes a writing frame and holding frames, and the writing frame and the holding frame include at least one light-emitting cycle, respectively; in the light-emitting cycle, a total duration of at least one active level of the first scanning signal is a first duration; and at the first frequency, first durations and/or bias voltages corresponding to at least some holding frames are different from those corresponding to the writing frame.

### CROSS-REFERENCE TO RELATED APPLICATIONS

The present application claims priority to Chinese Patent Application No. 202411918673.5, filed on Dec. 24, 2024, the content of which is incorporated herein by reference in its entirety.

### TECHNICAL FIELD

The present disclosure relates to the field of display technologies, and in particular, to a display panel and a driving method thereof, and a display device.

### BACKGROUND

Due to factors such as transistor leakage in a pixel circuit, when the display panel is driven at a low frequency, the brightness of the display panel cannot remain consistent and uniform as expected, resulting in flickering in a displayed image.

Such a flickering problem may bring some limitations to a range of driving frequency for the display panel, preventing the display panel from fully utilizing advantages of low-frequency power consumption reduction.

### SUMMARY

Embodiments of the present disclosure provide a display panel and a driving method thereof, and a display device, which can effectively improve the flickering phenomenon under low-frequency driving.

In a first aspect, an embodiment of the present disclosure provides a display panel, including: a pixel circuit, including a driving module and a bias adjustment module. The bias adjustment module has a control terminal electrically connected to a first scan line, a first terminal electrically connected to a bias signal line, and a second terminal electrically connected to a first terminal of the driving module, the first scan line provides a first scanning signal, and the bias signal line provides a bias voltage. The display panel has a first frequency, a driving cycle at the first frequency includes a writing frame and a plurality of holding frames, and the writing frame and each of the holding frames include at least one light-emitting cycle, respectively. In the light-emitting cycle, a total duration of at least one active level of the first scanning signal is a first duration. At the first frequency, first durations corresponding to at least some of the holding frames are different from a first duration corresponding to the writing frame, and/or bias voltages corresponding to at least some of the holding frames are different from a bias voltage corresponding to the writing frame.

In a second aspect, based on a same inventive concept, an embodiment of the present disclosure further provides a driving method of a display panel. The display panel includes a pixel circuit including a driving module and a bias adjustment module. The bias adjustment module has a control terminal electrically connected to a first scan line, a first terminal electrically connected to a bias signal line, and a second terminal electrically connected to a first terminal of the driving module. The first scan line provides a first scanning signal, and the bias signal line provides a bias voltage. The display panel has a first frequency, a driving cycle at the first frequency includes a writing frame and a plurality of holding frames, and the writing frame and each of the holding frames include at least one light-emitting cycle, respectively. In the light-emitting cycle, a total duration of at least one active level of the first scanning signal is a first duration. The driving method includes: at the first frequency, controlling first durations corresponding to at least some of the holding frames to be different from a first duration corresponding to the writing frame, and/or controlling bias voltages corresponding to at least some of the holding frames to be different from a bias voltage corresponding to the writing frame.

In a third aspect, based on the same inventive concept, an embodiment of the present disclosure further provides a display device including the above-mentioned display panel.

The technical solutions provided in the embodiments of the present disclosure have the following beneficial effects.

In the pixel circuit, a bias adjustment transistor is turned on in response to the active level of the first scanning signal, and the bias voltage is written into a gate of a driving transistor, thereby adjusting a bias state of the driving transistor. The conduction duration of the bias adjustment transistor and the magnitude of the bias voltage may affect the degree of regulation of the bias adjustment transistor on the bias state of the driving transistor, thereby affecting the device characteristics of the driving transistor, affecting the magnitude of the driving current, and further affecting the pixel brightness.

Compared to the writing frame, in the embodiments of the present disclosure, the total conduction duration and/or the bias voltage of the bias adjustment transistor in at least some of the holding frames is dynamically set, the bias state of the driving transistor is further adjusted during the holding phase, and the driving current during the holding phase is adjusted, suppressing the trend of brightness change during the holding phase, and weakening the brightness difference between the holding phase and the writing frame, thereby effectively improving the flickering phenomenon under low-frequency driving.

In addition, since the technical solution can effectively improve the flickering problem of low-frequency driving, the display panel can be driven at a lower frequency. The range for selecting the minimum driving frequency of the display panel can be set to be lower, and the display panel can better play the advantages of low-frequency power consumption reduction.

### BRIEF DESCRIPTION OF DRAWINGS

In order to better illustrate the technical solutions in embodiments of the present disclosure or the related art, the drawings used in the description of the embodiments will be briefly illustrated as follows. It should be noted that, the drawings described below are merely some of, rather than all of the embodiments of the present disclosure. Based on these drawings, those skilled in the art can obtain other drawings without any creative efforts.

FIG. 1 is a schematic diagram of brightness change in the related art;

FIG. 2 is a structural schematic diagram of a display panel according to an embodiment of the present disclosure;

FIG. 3 is a structural schematic diagram of a pixel circuit according to an embodiment of the present disclosure;

FIG. 4 is a timing diagram according to an embodiment of the present disclosure;

FIG. 5 is another timing diagram according to an embodiment of the present disclosure;

FIG. 6 is another timing diagram according to an embodiment of the present disclosure;

FIG. 7 is another timing diagram according to an embodiment of the present disclosure;

FIG. 8 is another timing diagram according to an embodiment of the present disclosure;

FIG. 9 is another timing diagram according to an embodiment of the present disclosure;

FIG. 10 is another timing diagram according to an embodiment of the present disclosure;

FIG. 11 is another timing diagram according to an embodiment of the present disclosure;

FIG. 12 is another timing diagram according to an embodiment of the present disclosure;

FIG. 13 is another timing diagram according to an embodiment of the present disclosure;

FIG. 14 is another timing diagram according to an embodiment of the present disclosure; and

FIG. 15 is a structural schematic diagram of a display device according to an embodiment of the present disclosure.

### DESCRIPTION OF EMBODIMENTS

In order to better understand the technical solutions of the present disclosure, the following is a detailed description of the embodiments of the present disclosure with reference to the drawings.

It should be clear that the embodiments described are only part of rather than all of the embodiments of the present disclosure. All other embodiments obtained by those skilled in the art based on the embodiments of the present disclosure without any creative effort should fall within the protection scope of the present disclosure.

The terms used in the embodiments of the present disclosure are merely intended to describe specific embodiments, but not intended to limit the present disclosure. The singular forms of “a/an”, “the” and “said” used in the embodiments of the present disclosure and the appended claims are also intended to include plural forms, unless clearly indicating others.

It should be understood that the term “and/or” used herein is merely an association relationship describing associated objects, indicating that there may be three relationships, for example, A and/or B, and may indicate: only A, both A and B, and only B. In addition, the character “/” herein generally means an “or” relationship between the associated objects.

At present, low-frequency driving of a display panel is usually implemented by reducing the frequency of a basic frequency. For example, the basic frequency of the display panel is 120 Hz, and one frame corresponding to the basic frequency is 8.33 ms. When the display panel needs to be driven at an ultra-low-frequency of 1 Hz, one driving cycle at 1 Hz includes one writing frame and 119 holding frames. The duration of the writing frame and the holding frame are both 8.33 ms. The data voltage is written into a gate of the driving transistor only in the writing frame, and is not written into the gate of the driving transistor in the holding frame.

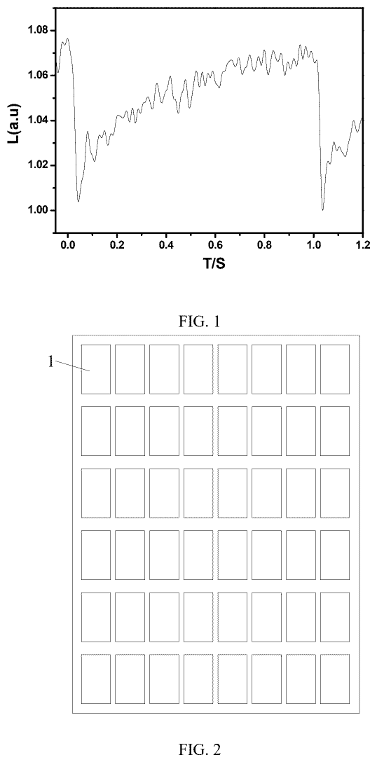

During low-frequency driving, due to factors such as the leakage of a gate reset transistor and a threshold compensation transistor that are connected to the gate of the driving transistor in the pixel circuit, the brightness in the holding phase may change. For example, when driven at 1 Hz, as shown in FIG. 1, which is a schematic diagram of brightness change in the related art, brightness continuously rises during the holding phase, causing an increasing difference from brightness of the writing frame, and brightness is not recovered until a next writing frame is entered. However, this may cause a very obvious brightness jump when entering the next writing frame, resulting in the flickering once every Is, which seriously affects the display quality.

In this regard, embodiments of the present disclosure provide a technical solution to effectively improve the above-mentioned flickering problem by adjusting the driving timing during the holding phase.

An embodiment of the present disclosure provides a display panel, as shown in FIG. 2, which is a structural schematic diagram of a display panel according to an embodiment of the present disclosure, the display panel includes a pixel circuit 1.

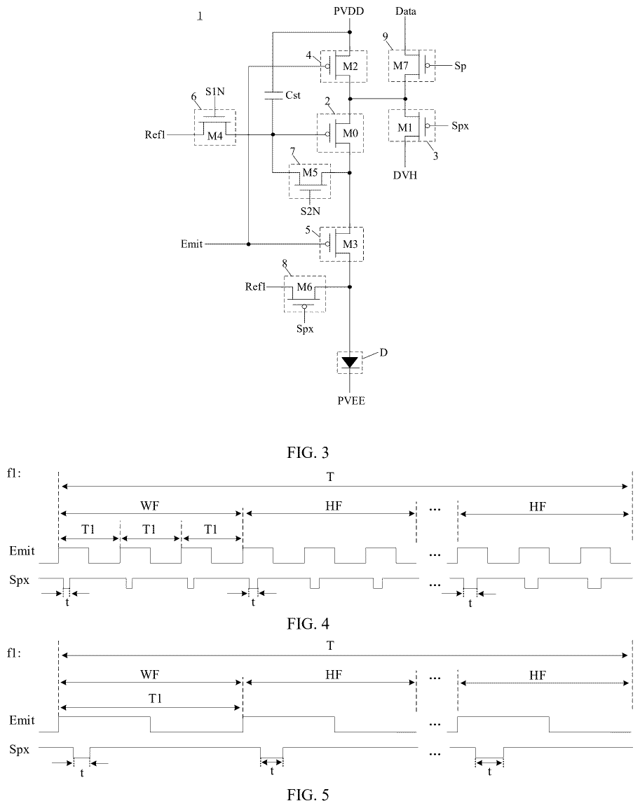

As shown in FIG. 3, which is a structural schematic diagram of a pixel circuit 1 according to an embodiment of the present disclosure, the pixel circuit 1 includes a driving module 2 and a bias adjustment module 3. The bias adjustment module 3 has a control terminal electrically connected to a first scan line Spx for providing a first scanning signal, a first terminal electrically connected to a bias signal line DVH for providing a bias voltage, and a second terminal electrically connected to a first terminal of the driving module 2.

In some embodiments, the driving module 2 includes a driving transistor M0. The bias adjustment module 3 includes a bias adjustment transistor M1 having a gate electrically connected to the first scan line Spx, a first electrode electrically connected to the bias signal line DVH, and a second electrode electrically connected to a first electrode of the driving transistor M0. The bias adjustment transistor M1 is turned on in response to an active level provided by the first scan line Spx, and the bias voltage is written into the first electrode of the driving transistor M0 to adjust the bias state of the driving transistor M0.

Referring to FIG. 4 to FIG. 7, the display panel has a first frequency f1, and the first frequency f1 may be a lower frequency, such as 1 Hz, 2 Hz, 5 Hz, 10 Hz, and 20 Hz. The driving cycle T at the first frequency f1 includes a writing frame WF and a plurality of holding frames HF, and the writing frame WF and each of the holding frames HF include at least one light-emitting cycle T1, respectively.

Regarding the writing frame WF and the holding frames HF: the display panel has a basic frequency f, and one frame corresponding to the basic frequency f is

$$\frac{1}{f} s .$$

The driving cycle T at the first frequency f1 includes one writing frame WF and

$$\frac{f}{f 1} - 1$$

holding frames HF, and the duration of the writing frame WF and the holding frame HF are both

$$\frac{1}{f} s .$$

Regarding the light-emitting cycle T1: referring to FIG. 3, the display panel further includes a first light-emitting control module 4 and a second light-emitting control module 5. The first light-emitting control module 4 has a control terminal electrically connected to a light-emitting control signal line Emit, a first terminal electrically connected to a first power line PVDD, and a second terminal electrically connected to the first terminal of the driving module 2. The second light-emitting control module 5 has a control terminal electrically connected to the light-emitting control signal line Emit, a first terminal electrically connected to a second terminal of the driving module 2, and a second terminal electrically connected to a light-emitting element D.

In some embodiments, the first light-emitting control module 4 includes a first light-emitting control transistor M2, and the first light-emitting control transistor M2 has a gate electrically connected to the light-emitting control signal line Emit, a first electrode electrically connected to the first power line PVDD, and a second electrode electrically connected to the first electrode of the driving transistor M0. The second light-emitting control module 5 includes a second light-emitting control transistor M3, and the second light-emitting control transistor M3 has a gate electrically connected to the light-emitting control signal line Emit, a first electrode electrically connected to the second electrode of the driving transistor M0, and a second electrode electrically connected to the light-emitting element D.

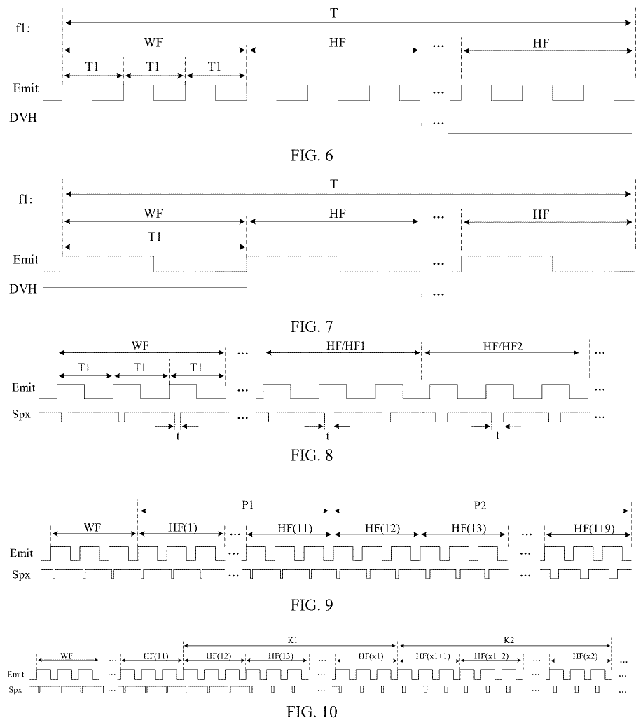

Referring to FIG. 4 to FIG. 7, the light-emitting control signal line Emit provides a light-emitting control signal, and one light-emitting cycle T1 may be understood as one pulse period of the light-emitting control signal. In some embodiments, the writing frame WF and the holding frame HF can include one light-emitting cycle T1, respectively, as shown in FIG. 5 and FIG. 7, or may include at least two light-emitting cycles T1, respectively, as shown in FIG. 4 and FIG. 6. When the writing frame WF and the holding frame HF include at least two light-emitting cycles T1, respectively, the brightness can be more finely adjusted using the light-emitting control signal. The drawings of the embodiments of the present disclosure are illustrated by taking an example in which the writing frame WF and the holding frame HF include three light-emitting cycles T1, respectively.

As shown in FIG. 4 and FIG. 5, where FIG. 4 is a timing diagram according to an embodiment of the present disclosure, and FIG. 5 is another timing diagram according to an embodiment of the present disclosure, at the first frequency f1, first durations corresponding to at least some of the holding frames HF are different from a first duration corresponding to the writing frame WF, and the first duration is a total duration of at least one active level of the first scanning signal in the light-emitting cycle T1. That is, for one light-emitting cycle T1, when the first scanning signal provides only one pulse, the first duration is a duration of an active level in the pulse, and when the first scanning signal provides at least two pulses, the first duration is a sum of durations of active levels in the at least two pulses. The first durations corresponding to at least some of the holding frames HF are different from the first duration corresponding to the writing frame WF, which means that the total conduction duration of the bias adjustment transistor M1 in each of at least some of the holding frames HF is different from the total conduction duration of the bias adjustment transistor M1 in the writing frame WF.

In some embodiments, the bias adjustment transistor M1 is a P-type transistor, and correspondingly, the active level of the first scanning signal is a low level.

Additionally/Alternatively, as shown in FIG. 6 and FIG. 7, where FIG. 6 is another timing diagram according to an embodiment of the present disclosure, and FIG. 7 is another timing diagram according to an embodiment of the present disclosure, at the first frequency f1, bias voltages corresponding to at least some of the holding frames HF are different from a bias voltage corresponding to the writing frame WF.

In the pixel circuit 1, the bias adjustment transistor M1 is turned on in response to the active level of the first scanning signal, and the bias voltage is written into the gate of the driving transistor M0, thereby adjusting the bias state of the driving transistor M0. The conduction duration of the bias adjustment transistor M1 and the magnitude of the bias voltage may affect the degree of regulation of the bias adjustment transistor M1 on the bias state of the driving transistor M0, thereby affecting the device characteristics of the driving transistor M0, affecting the magnitude of the driving current, and further affecting the pixel brightness.

Compared to the writing frame WF, in the embodiments of the present disclosure, the conduction total duration and/or the bias voltage of the bias adjustment transistor M1 in at least some of the holding frames HF is dynamically set, the bias state of the driving transistor M0 is further adjusted during the holding phase, and the driving current is adjusted during the holding phase, suppressing the trend of brightness change during the holding phase, and weakening the brightness difference between the holding phase and the writing frame WF, thereby effectively improving the flickering phenomenon under low-frequency driving.

In addition, since the technical solution can effectively improve the flickering problem of low-frequency driving, the display panel can be driven at a lower frequency. The range for selecting the minimum driving frequency of the display panel can be set to be lower, and the display panel can better play the advantages of low-frequency power consumption reduction.

Referring to FIG. 3, the pixel circuit 1 further includes a gate reset module 6 and a threshold compensation module 7. The gate reset module 6 has a control terminal electrically connected to a second scan line SiN, a first terminal electrically connected to a first reset line Ref1, and a second terminal electrically connected to a control terminal of the driving module 2. The threshold compensation module 7 has a control terminal electrically connected to a third scan line S2N, a first terminal electrically connected to a second terminal of the driving module 2, and a second terminal electrically connected to the control terminal of the driving module 2.

In some embodiments, the gate reset module 6 includes a gate reset transistor M4, which can be an indium gallium zinc oxide (IGZO) transistor, and the gate reset transistor has a gate electrically connected to the second scan line SiN, a first electrode electrically connected to the first reset line Ref1, and a second electrode electrically connected to the gate of the driving transistor M0. The threshold compensation module 7 includes a threshold compensation transistor M5, which can also be an IGZO transistor, and the threshold compensation transistor has a gate electrically connected to the third scan line S2N, a first electrode electrically connected to the second electrode of the driving transistor M0, and a second electrode electrically connected to the gate of the driving transistor M0.

Generally, referring to FIG. 1, due to the influence of the leakage of the gate reset transistor M3 and the threshold compensation transistor M4, the brightness in the holding phase can show a rising trend during low-frequency driving.

To suppress the rising trend, in a feasible implementation, referring to FIG. 4 and FIG. 5, the first durations corresponding to at least some holding frames HF are greater than the first duration corresponding to the writing frame WF.

That is, compared to the writing frame WF, in at least some holding frames HF, the total conduction durations of the bias adjustment transistor M1 increases, and the control time of the bias adjustment transistor M1 for the driving transistor M0 are prolonged, so that the device characteristics of the driving transistor M0 can be controlled to a greater extent, thereby suppressing the rising trend of the brightness in the holding phase, and weakening the brightness difference between the holding phase and the writing frame WF.

In a feasible implementation, as shown in FIG. 8, which is another timing diagram according to an embodiment of the present disclosure, the holding frames HF include a first holding frame HF1 and a second holding frame HF2, and the first holding frame HF1 is located between the writing frame WF and the second holding frame HF2.

A first duration corresponding to the second holding frame HF2 is greater than a first duration corresponding to the first holding frame HF1.

In the related art, referring to FIG. 1, the holding frame HF farther away from the writing frame WF has a larger brightness difference with the writing frame WF. In the above-mentioned configuration manner, by setting the first duration corresponding to the first holding frame HF1 close to the writing frame WF to be slightly smaller, and setting the first duration corresponding to the second holding frame HF2 away from the writing frame WF to be slightly larger, timing settings of the first holding frame HF1 and the second holding frame HF2 can be adjusted in a more targeted manner, so that the brightness of the first holding frame HF1 and the brightness of the second holding frame HF2 are both adjusted toward a direction closer to the brightness of the writing frame WF.

In a feasible implementation, referring to FIG. 4, FIG. 5, and FIG. 8, when the first durations corresponding to at least some holding frames HF are greater than the first duration corresponding to the writing frame WF, second durations t corresponding to at least some of the holding frames HF can be set to be greater than a second duration t corresponding to the writing frame WF. The second duration t is a duration of a single active level in the first scanning signal, that is, a low level duration of a single pulse in the first scanning signal.

Compared to the writing frame WF, such driving manner may not change the number of pulses of the first scanning signal in the holding frame HF, but only increase the duration of the active level in the first scanning signal. The duration of the active level in the first scanning signal increases, which can increase the adjustment time of the bias adjustment transistor M1 on the bias state of the driving transistor M0, thereby suppressing the rising trend of the brightness in the holding phase, and weakening the brightness difference between the holding phase and the writing frame WF.

In this regard, according to the embodiments of the present disclosure, the brightness of the holding frame is tested based on some different second durations. At 1 Hz, when the second duration is 24H, the brightness of the holding frame HF is 0.01640 nits; when the second duration is 28H, the brightness of the holding frame HF is 0.01609 nits; when the second duration is 32H, the brightness of the holding frame HF is 0.01580 nits; and when the second duration is 36H, the brightness of the holding frame HF is 0.01556 nits. It can be seen that the larger the second duration is, the lower the brightness of the holding frame is, which can effectively suppress the rising trend of the brightness in the holding phase.

Further, as shown in FIG. 9, which is another timing diagram according to an embodiment of the present disclosure, second durations corresponding to at least some continuous holding frames HF increase gradually.

For example, referring to FIG. 9, the driving cycle T at 1 Hz includes holding frames HF from a first holding frame HF(1) to a 119th holding frame HF(119), and second durations corresponding to holding frames HF from a 12th holding frame HF(12) to the 119th holding frame HF(119) increase gradually.

In such configuration manner, the second durations corresponding to multiple holding frames HF are adjusted incrementally, so that the brightness in the multiple holding frames HF is adjusted more finely, and the brightness of each holding frame HF can adjusted to be close to the brightness of the writing frame WF, and the improvement effect is better.

Alternatively, as shown in FIG. 10, which is another timing diagram according to an embodiment of the present disclosure, the driving cycle T includes a first holding period K1 and a second holding period K2. The first holding period K1 and the second holding period K2 include at least two holding frames HF, respectively, and the first holding period K1 is located between the writing frame WF and the second holding period K2.

Second durations corresponding to different holding frames HF in the first holding period K1 are equal, and second durations corresponding to different holding frames HF in the second holding period K2 are equal. The second durations corresponding to the second holding period K2 are greater than the second durations corresponding to the first holding period K1.

For example, referring to FIG. 10, the driving cycle T at 1 Hz includes holding frames HF from a first holding frame HF(1) to a 119th holding frame HF(119), where the first holding period K1 includes holding frames HF from a 12th holding frame HF(12) to a x1-th holding frame HF(x1), and the second holding period K2 includes holding frames HF from a (x1+1)-th holding frame HF(x1+1) to a x2-th holding frame HF(x2).

The number of holding frames HF included in the first holding period K1 and the number of holding frames HF included in the second holding period K2 may be the same or different.

In some embodiments, the driving cycle T includes a plurality of holding periods, and each holding period includes at least two holding frames HF. The second durations corresponding to different holding frames HF in each holding period are equal, and the second durations corresponding to the holding periods increase gradually. A previous holding period in any two adjacent holding periods can be understood as a first holding period K1, and a subsequent holding period in any two adjacent holding periods can be understood as a second holding period K2.

In such configuration manner, the second duration is adjusted using the holding period as a unit, and the setting of the second duration is relatively simple, which is more applicable to a case where a large number of holding frames HF are present.

Further, a difference between second durations corresponding to at least some of adjacent holding frames HF is Δt, and 2H≤Δτ≤8H.

H represents a row time,

$$H = \frac{1}{f \times n} ,$$

f represents a basic frequency of the display panel, and n represents the number of rows of the pixel circuits 1 in the display panel.

Setting the minimum value of Δt to be 2H can ensure that the rising trend of brightness in the holding phase is suppressed to a sufficient degree. The maximum value of Δt is set to 8H, so that the second duration corresponding to the later holding frame HF can be prevented from being too large when the number of holding frames HF is larger. Since the high level of the light-emitting control signal needs to cover the low level of the first scanning signal, if the second duration corresponding to the holding frame HF is too large, the duration of the high level of the light-emitting control signal needs to be set larger, which may compress the light-emitting time and affect the brightness.

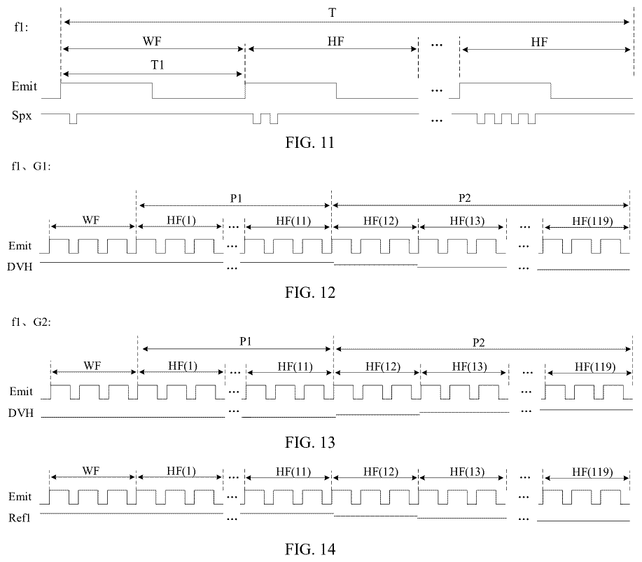

When the first durations corresponding to at least some holding frames HF are greater than the first duration corresponding to the writing frame WF, in another feasible implementation, as shown in FIG. 11, which is another timing diagram according to an embodiment of the present disclosure, first quantities corresponding to at least some holding frames HF are greater than a first quantity corresponding to the writing frame WF, where the first quantity is the number of the at least one active level of the first scanning signal in the light-emitting cycle T1, that is, the number of pulses of the first scanning signal in the light-emitting cycle T1.

For example, referring to FIG. 11, at 1 Hz, the first scanning signal in one light-emitting cycle T1 has one pulse in the writing frame WF, and the first scanning signal in one light-emitting cycle T1 has two or more pulses in any of holding frames HF from the 12th holding frame HF(12) to the 119th holding frame HF(119).

Compared to the writing frame WF, such driving manner can only increase the number of pulses of the first scanning signal in the light-emitting cycle T1 without changing the duration of the active level in the first scanning signal in the holding frame HF. Increasing the number of pulses of the first scanning signal in the light-emitting cycle T1 can also increase the total conduction duration of the bias adjustment transistor M1, thereby increasing the degree of adjustment of the bias adjustment transistor M1 to the bias state of the driving transistor M0, and suppressing the rising trend of the brightness in the holding phase.

Regarding the influence of the brightness of the bias voltage, it has found that the effect of the bias voltage is mainly reflected in two aspects.

In a first aspect, the bias voltage affects the bias of the driving transistor M0, thereby affecting the device state of the driving transistor M0. The higher the bias voltage, the more negative the gate-source voltage Vgs of the driving transistor M0, and the greater the negative bias of the threshold voltage of the driving transistor M0. When the gate voltage of the driving transistor M0 remains unchanged, the greater the negative bias of the threshold voltage of the driving transistor M0, the lower the brightness of the pixel.

In a second aspect, the bias voltage can affect the charging of the light-emitting element. The higher the bias voltage, the more positive charges are stored in the pixel circuit 1 for the light-emitting element to light up and emit light, resulting in an increase in the brightness of the pixel.

When the low-gray-level display is performed, the charging of the light-emitting element can be greatly affected by the positive charges in the pixel circuit 1, and thus the influence of the bias voltage on the brightness is mainly embodied in the second aspect. When the high-gray-level display is performed, the brightness of the light-emitting element is mainly affected by the device state of the driving transistor M0, and thus the influence of the bias voltage on the brightness is mainly embodied in the first aspect.

In this regard, in a feasible implementation, as shown in FIG. 12, which is another timing diagram according to an embodiment of the present disclosure, at a first gray level G1 of the first frequency f1, the bias voltages corresponding to at least some of the holding frames HF are less than the bias voltage corresponding to the writing frame WF. The first gray level G1 is less than 128, which can be understood as a low gray level.

At the first gray level G1, the display panel performs low-gray-level display. As described above, the influence of the bias voltage on the brightness is mainly embodied in the second aspect. Therefore, compared to the writing frame WF, by setting the bias voltage corresponding to the holding frame HF to be lower, the positive charges stored in the pixel circuit 1 for the light-emitting element to light up and emit light can be reduced to achieve the purpose of reducing the brightness, thereby effectively suppressing the rising trend of the brightness in the holding phase, and improving the flickering phenomenon under the low gray level.

In this regard, according to the embodiments of the present disclosure, the brightness of the holding frame is also tested based on some different bias voltages. When driven at 1 Hz, if the bias voltage is 7.2V, the brightness is 0.02246 nits; if the bias voltage is 7.15V, the brightness is 0.02079 nits; if the bias voltage is 7.1V, the brightness is 0.01887 nits; if the bias voltage is 7.05V, the brightness is 0.01733 nits; and if the bias voltage is 7V, the brightness is 0.01574 nits. It can be seen that the smaller the bias voltage, the lower the brightness, and the suppression of the rising trend of the brightness is more obvious.

Further, the first gray level G1 is less than or equal to 16.

The lower the gray level, the more easily the picture flickering is visible to human eyes. In the embodiments of the present disclosure, the setting for the display at the gray level 16 and below is made in a more targeted manner, which can significantly reduce low-gray-level flickering while saving some power consumption.

In a feasible implementation, as shown in FIG. 13, which is another timing diagram according to an embodiment of the present disclosure, at a second gray level G2 of the first frequency f1, the bias voltages corresponding to at least some of the holding frames HF are greater than the bias voltage corresponding to the writing frame WF. The second gray level G2 is greater than or equal to 128, which can be understood as a high gray level.

At the second gray level G2, the display panel performs high-gray-level display. As described above, the influence of the bias voltage on the brightness is mainly embodied in the first aspect. Therefore, compared to the writing frame WF, the bias voltages corresponding to at least some of the holding frames HF are set higher, and after the bias state of the driving transistor M0 is adjusted by using the bias adjustment transistor M1, the negative bias degree of the threshold voltage of the driving transistor M0 can be increased to achieve the purpose of reducing the brightness, thereby effectively suppressing the rising trend of the brightness in the holding phase, and improving the flickering phenomenon under the high gray level.

In a feasible implementation, bias voltages corresponding to at least some continuous ones of the holding frames HF gradually change, and further, the change of these bias voltages can be a gradient with equal difference.

For example, at 1 Hz, under the first gray level G1, the bias voltages corresponding to holding frames HF from the 12th holding frame HF(12) to the 119th holding frame HF(119) decrease gradually, for example, 7.15V, 7.14V, 7.13V, in sequence, and under the second gray level G2, the bias voltages corresponding to holding frames HF from the 12th holding frame HF (12) to the 119th holding frame HF(119) increase gradually, for example, 7V, 7.01V, 7.02V, in sequence.

In such configuration manner, the bias voltages corresponding to the holding frames HF are adjusted gradually, so that the brightness in the holding frames HF is adjusted more finely, and the brightness of each holding frame HF can be adjusted to be close to the brightness of the writing frame WF, and the improvement effect is better.

Alternatively, the driving cycle T includes a first holding period K1 and a second holding period K2. The first holding period K1 and the second holding period K2 include at least two holding frames HF, respectively, and the first holding period K1 is located between the writing frame WF and the second holding period K2.

The bias voltages corresponding to the first holding period K1 are equal, and the bias voltages corresponding to the second holding period K2 are equal. The bias voltages corresponding to the first holding period K1 are different from the bias voltages corresponding to the second holding period K2.

Exemplarily, at 1 Hz, the first holding period K1 includes holding frames HF from a 12th holding frame HF(12) to a x1-th holding frame HF(x1), and bias voltages corresponding to the holding frames HF from the 12th holding frame HF(12) to the x1-th holding frame HF(x1) are equal. The second holding period K2 includes holding frames HF from a (x1+1)-th holding frame HF(x1+1) to a x2-th holding frame HF(x2), and bias voltages corresponding to the holding frames HF from the (x1+1)-th holding frame HF(x1+1) to the x2-th holding frame HF(x2) are equal. Under the first gray level G1, the bias voltages corresponding to the first holding period K1 are greater than the bias voltages corresponding to the second holding period K2, and under the second gray level G2, the bias voltages corresponding to the first holding period K1 are less than the bias voltages corresponding to the second holding period K2.

The number of holding frames HF included in the first holding period K1 and the number of holding frames HF included in the second holding period K2 may be the same or different.

In some embodiments, the driving cycle T includes a plurality of holding periods, and each holding period includes at least two holding frames HF. Bias voltages corresponding to different holding frames HF in the holding period are equal, and bias voltages corresponding to multiple holding periods increase gradually or decrease gradually. In such driving manner, a previous holding period in any two adjacent holding periods can be understood as a first holding period K1, and a subsequent holding period in any two adjacent holding periods can be understood as a second holding period K2.

In such configuration manner, the bias voltage is adjusted using the holding period as a unit, and the setting of the bias voltage is relatively simple, which is more applicable to a case where a large number of holding frames HF are present.

Further, a difference between bias voltages corresponding to at least some of adjacent holding frames HF is ΔV, where 0.01V≤|ΔV|≤0.1V.

Setting the minimum value of |ΔV| to be 0.01H can ensure that the rising trend of brightness in the holding phase is suppressed to a sufficient degree. The maximum value of |ΔV| is set to 0.1V, so that when the number of holding frames HF is larger, the bias voltage corresponding to the later holding frame HF is prevented from being too large or too small, thereby reducing the design difficulty of the bias voltage.

In a feasible implementation, referring to FIG. 9, FIG. 12, and FIG. 13, the driving cycle T includes a first period P1 and a second period P2, the first period P1 is located between the writing frame WF and the second period P2, and the first period P1 and the second period P2 include a plurality of holding frames HF, respectively.

The first durations corresponding to the first period P1 are equal to the first duration corresponding to the writing frame WF, and the bias voltages corresponding to the first period P1 are equal to the bias voltage corresponding to the writing frame WF. The first durations corresponding to the second period P2 are different from the first duration corresponding to the writing frame WF, and/or the bias voltages corresponding to the second period P2 are different from the bias voltage corresponding to the writing frame WF.

The first period P1 is close to the writing frame WF, the brightness change in this period is not very obvious, and the brightness difference from the writing frame WF is relatively small. Therefore, the first durations and the bias voltages corresponding to the first period P1 can be set to be the same as the writing frame WF, and only the first durations and/or the bias voltages corresponding to the second period P2 are set to be different from the writing frame WF, thereby saving power consumption.

Further, the display panel further has a basic frequency f and a second frequency f2, where f>f2>f1. The driving cycle T at the first frequency f1 includes

$$\frac{f}{f 1} - 1$$

holding frames HF, the first period P1 includes holding frames HF from a first holding frame HF to a

$$( \frac{f}{f 2} - 1 ) - th$$

holding frame HF, and the second period P2 includes holding frames HF from a

$$( \frac{f}{f 2} ) - th$$

holding frame HF to a

$$( \frac{f}{f 1} - 1 ) - th$$

holding frame HF.

In some embodiments, referring to FIG. 9, FIG. 12, and FIG. 13, the basic frequency f is 120 Hz, the first frequency f1 is 1 Hz, and the second frequency f2 is 10 Hz. The driving cycle T at 1 Hz includes one writing frame WF and 119 holding frames HF, and the driving cycle T at 10 Hz includes one writing frame WF and 11 holding frames HF. At the first frequency f1, the first period P1 includes holding frames HF from a first holding frame HF(1) to a 11th holding frame HF(11), and the second period P2 includes holding frames HF from a 12th holding frame HF(12) to a 119th holding frame HF(119).

This driving manner is more applicable to a case where the first frequency f1 is an ultra-low frequency. The second frequency f2 is greater than the first frequency f1, which means that the number of the holding frames HF in the driving cycle T corresponding to the second frequency f2 is less, the rising degree of the brightness in the corresponding holding phase is not too large, and the flickering is less obvious.

In order to save power consumption and reduce the design difficulty of the first duration and the bias voltage, at the first frequency f1, the setting of the first

$$\frac{f}{f 2} - 1$$

holding frames HF can be selected to be unchanged, where

$$\frac{f}{f 2} - 1$$

is the number of holding frames HF in the driving cycle T corresponding to the second frequency f2, and only the first durations and/or the bias voltages corresponding to the

$$( \frac{f}{f 2} ) - th$$

and subsequent holding frames HF are adjusted.

In a feasible implementation, in combination with FIG. 3 and FIG. 4, the first durations corresponding to at least some of the holding frames HF are different from the first duration corresponding to the writing frame WF. For example, the first durations corresponding to at least some of the holding frames HF are greater than the first duration corresponding to the writing frame WF.

The pixel circuit 1 further includes an anode reset module 8 having a control terminal electrically connected to the first scan line Spx, a first terminal electrically connected to the first reset line Ref1, and a second terminal electrically connected to the light-emitting element D.

In some embodiments, the anode reset module 8 includes an anode reset transistor M6, and the anode reset transistor M6 has a gate electrically connected to the first scan line Spx, a first electrode electrically connected to the first reset line Ref1, and a second electrode electrically connected to the light-emitting element D.

The anode reset transistor M6 is turned on in response to the active level of the first scanning signal, and the first reset voltage is written into the light-emitting element D to reset an anode voltage of the light-emitting element D. The first durations corresponding to at least some of the holding frames HF increase, which means that the total conduction durations of the anode reset transistor M6 in these holding frames HF are also longer, so that the reset degree of the anode reset transistor M6 to the anode potential of the light-emitting element D can be increased, and the anode potential is reset more thoroughly, thereby reducing the light-emitting brightness, suppressing the rising trend of the brightness in the holding phase, and further improving the flickering.

In a feasible implementation, as shown in FIG. 14, which is another timing diagram according to an embodiment of the present disclosure, the pixel circuit 1 further includes an anode reset module 8, and the anode reset module 8 has a first terminal electrically connected to the first reset line Ref1 for providing a first reset voltage, and a second terminal electrically connected to the light-emitting element D.

First reset voltages corresponding to at least some of the holding frames HF are less than a first reset voltage corresponding to the writing frame WF.

Compared to the writing frame WF, reducing the first reset voltages corresponding to at least some of the holding frames HF can reduce the anode potential of the light-emitting element D after being reset, thereby reducing the light-emitting brightness, suppressing the rising trend of the brightness in the holding phase, and further improving the flickering.

In a feasible implementation, the first frequency f1 is less than 10 Hz.

The lower the frequency, the more the number of the holding frames HF included in the driving cycle T, the greater the rising degree of brightness in the holding phase, and the more obvious the brightness difference from the writing frame WF. Therefore, in the embodiments of the present disclosure, the above adjustment on an ultra-low frequency below 10 Hz can be made in a more targeted manner, thereby effectively improving the flickering problem under ultra-low driving while saving some power consumption.

Regarding the pixel circuit 1, referring to FIG. 3, the pixel circuit 1 further includes a data writing module 9, and the data writing module 9 has a control terminal electrically connected to a fourth scan line Sp, a first terminal electrically connected to a data line Data, and a second terminal electrically connected to the first terminal of the driving module 2.

In some embodiments, the data writing module 9 includes a data writing transistor M9, and the data writing transistor M9 has a gate electrically connected to the fourth scan line Sp, a first electrode electrically connected to the data line Data, and a second electrode electrically connected to the first electrode of the driving transistor M0.

The pixel circuit 1 further includes a storage capacitor Cst electrically connected between a first power supply line PVDD and the gate of the driving transistor M0.

A cathode of the light-emitting element D is electrically connected to a second power line PVEE.

Based on a same inventive concept, an embodiment of the present disclosure further provides a driving method of a display panel. Referring to FIG. 2 and FIG. 3, the display panel includes a pixel circuit 1 including a driving module 2 and a bias adjustment module 3, where the bias adjustment module 3 has a control terminal electrically connected to a first scan line Spx, a first terminal electrically connected to a bias signal line DVH, a second terminal electrically connected to a first terminal of the driving module 2. The first scan line Spx provides a first scanning signal, and the bias signal line DVH provides a bias voltage.

Referring to FIG. 4 to FIG. 7, the display panel has a first frequency f1, and the driving cycle T at the first frequency f1 includes a writing frame WF and a plurality of holding frames HF. The writing frame WF and each of the holding frames HF include at least one light-emitting cycle T1, respectively.

The driving method includes: at the first frequency f1, controlling first durations corresponding to at least some of the holding frames HF to be different from a first duration corresponding to the writing frame WF, and the first duration is a total duration of at least one active level of the first scanning signal in a light-emitting cycle T1, and/or controlling bias voltages corresponding to at least some of the holding frames HF to be different from a bias voltage corresponding to the writing frame WF.

In combination with the foregoing analysis, by using the driving method, compared to the writing frame WF, in the embodiments of the present disclosure, the total conduction duration and/or the bias voltage of the bias adjustment transistor M1 in at least some of the holding frames HF is dynamically set, the bias state of the driving transistor M0 is further adjusted during the holding phase, and the driving current is adjusted during the holding phase, suppressing the trend of brightness change during the holding phase, and weakening the brightness difference between the holding phase and the writing frame WF, thereby effectively improving the flickering phenomenon under low-frequency driving.

In addition, since the technical solution can effectively improve the flickering problem of low-frequency driving, the display panel can be driven at a lower frequency. The range for selecting the minimum driving frequency of the display panel can be set to be lower, and the display panel can better play the advantages of low-frequency power consumption reduction.

In a feasible implementation, referring to FIG. 4 and FIG. 5, the first durations corresponding to at least some of the holding frames HF are greater than the first duration corresponding to the writing frame WF.

That is, compared to the writing frame WF, in at least some of the holding frames HF, the total conduction duration of the bias adjustment transistor M1 increases, and the control duration of the bias adjustment transistor M1 for the driving transistor M0 is prolonged, so that the device characteristics of the driving transistor M0 can be controlled to a greater extent, thereby suppressing the rising trend of the brightness in the holding phase, and weakening the brightness difference between the holding phase and the writing frame WF.

In a feasible implementation, referring to FIG. 4, FIG. 5, and FIG. 8, second durations t corresponding to at least some of the holding frames HF are greater than a second duration t corresponding to the writing frame WF, and the second duration t is the duration of the active level in the first scanning signal.

Compared to the writing frame WF, such driving manner may not change the number of pulses of the first scanning signal in the holding frame HF, but only increase the duration of the active level in the first scanning signal. The duration of the active level in the first scanning signal increases, which can increase the adjustment duration of the bias adjustment transistor M1 on the bias state of the driving transistor M0, thereby suppressing the rising trend of the brightness in the holding phase, and weakening the brightness difference between the holding phase and the writing frame WF.

Additionally/Alternatively, referring to FIG. 11, in the light-emitting cycle T1, the number of at least one active level in the first scanning signal is a first quantity, and the first quantities corresponding to at least some of the holding frames HF are greater than the first quantity corresponding to the writing frame WF.

Compared to the writing frame WF, such driving manner can only increase the number of pulses of the first scanning signal in the light-emitting cycle T1 without changing the duration of the active level in the first scanning signal in the holding frame HF. Increasing the number of pulses of the first scanning signal in the light-emitting cycle T1 can also increase the total conduction duration of the bias adjustment transistor M1, thereby increasing the adjustment degree of the bias adjustment transistor M1 to the bias state of the driving transistor M0, and suppressing the rising trend of the brightness in the holding phase.

In a feasible implementation, referring to FIG. 12, at the first gray level G1 of the first frequency f1, the bias voltages corresponding to at least some of the holding frames HF are less than the bias voltage corresponding to the writing frame WF, and the first gray level G1 is less than 128. Additionally/Alternatively, at the second gray level G2 of the first frequency f1, the bias voltages corresponding to at least some of the holding frames HF are greater than the bias voltage corresponding to the writing frame WF, and the second gray level G2 is greater than or equal to 128.

As described above, the effect of the bias voltage is mainly reflected in two aspects.

At the first gray level G1, the display panel performs low-gray-level display. As described above, the influence of the bias voltage on the brightness is mainly embodied in the second aspect. Therefore, compared to the writing frame WF, by setting the bias voltage corresponding to the holding frame HF to be lower, the positive charges stored in the pixel circuit 1 for the light-emitting element to light up and emit light can be reduced to achieve the purpose of reducing the brightness, thereby effectively suppressing the rising trend of the brightness in the holding phase, and improving the flickering phenomenon under the low gray level.

At the second gray level G2, the display panel performs high-gray-level display. As described above, the influence of the bias voltage on the brightness is mainly embodied in the first aspect. Therefore, compared to the writing frame WF, by setting the bias voltages corresponding to at least some of the holding frames HF to be higher, after the bias state of the driving transistor M0 is adjusted by using the bias adjustment transistor M1, the negative bias degree of the threshold voltage of the driving transistor M0 can be increased to achieve the purpose of reducing the brightness, thereby effectively suppressing the rising trend of the brightness in the holding phase, and improving the flickering phenomenon under the high gray level.

In a feasible implementation, referring to FIG. 9, FIG. 12, and FIG. 13, the driving cycle T includes a first period P1 and a second period P2, the first period P1 is located between the writing frame WF and the second period P2, and the first period P1 and the second period P2 include a plurality of holding frames HF, respectively.

The first durations corresponding to the first period P1 are equal to the first duration corresponding to the writing frame WF, and the bias voltages corresponding to the first period P1 are equal to the bias voltage corresponding to the writing frame WF. The first durations corresponding to the second period P2 are different from the first duration corresponding to the writing frame WF, and/or the bias voltages corresponding to the second period P2 are different from the bias voltage corresponding to the writing frame WF.

The first period P1 is close to the writing frame WF, the brightness change in this period is not very obvious, and the brightness difference from the writing frame WF is relatively small. Therefore, the first durations and the bias voltages corresponding to the first period P1 can be set to be the same as the writing frame WF, and only the first durations and/or the bias voltages corresponding to the second period P2 are set to be different from the writing frame WF, thereby saving power consumption.

Further, the display panel has a basic frequency f and a second frequency f2, where f>f2>f1.

The driving cycle T includes

$$( \frac{f}{f 1} - 1 )$$

holding frames HF, the first period P1 includes holding frames HF from a first holding frame HF to a

$$( \frac{f}{f 2} - 1 ) - th$$

holding frame HF, and the second period P2 includes holding frames HF from a

$$( \frac{f}{f 2} ) - th$$

holding frame HF to a

$$( \frac{f}{f 1} - 1 ) - th$$

holding frame HF.

In some embodiments, referring to FIG. 9, FIG. 12, and FIG. 13, the basic frequency f is 120 Hz, the first frequency f1 is 1 Hz, and the second frequency f2 is 10 Hz. The driving cycle T at 1 Hz includes one writing frame WF and 119 holding frames HF, and the driving cycle T at 10 Hz includes one writing frame WF and 11 holding frames HF. At the first frequency f1, the first period P1 includes holding frames HF from a first holding frame HF(1) to a 11th holding frame HF(11), and the second period P2 includes holding frames HF from a 12th holding frame HF(12) to a 119th holding frame HF(119).

This driving manner is more applicable to a case where the first frequency f1 is an ultra-low frequency. The second frequency f2 is greater than the first frequency f1, which means that the number of the holding frames HF in the driving cycle T corresponding to the second frequency f2 is less, the rising degree of the brightness in the corresponding holding phase is not too large, and flickering is less obvious.

In order to save power consumption and reduce the design difficulty of the first duration and the bias voltage, at the first frequency f1, the setting of the first

$$\frac{f}{f 2} - 1$$

holding frames HF can be selected to be unchanged, where

$$\frac{f}{f 2} - 1$$

is the number of holding frames HF in the driving cycle T corresponding to the second frequency f2, and only the first durations and/or the bias voltages corresponding to the

$$( \frac{f}{f 2} ) - th$$

and subsequent holding frames HF are adjusted.

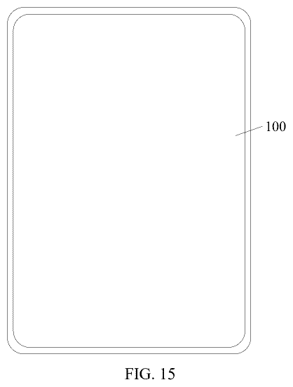

Based on the same inventive concept, an embodiment of the present disclosure further provides a display device. As shown in FIG. 15, which is a structural schematic diagram of a display device according to an embodiment of the present disclosure, the display device includes the above-mentioned display panel 100. It is understandable that, the display device shown in FIG. 15 is merely illustrative, and the display device may be any electronic device having a display function, such as a mobile phone, a tablet computer, a notebook computer, an e-book or a television.

The above description is only preferred embodiments of the present disclosure and is not intended to limit the present disclosure, and any modifications, equivalent substitutions, improvements and the like made within the spirit and principle of the present disclosure should be included within the protection scope of the present disclosure.

Finally, it should be noted that, the above embodiments are merely used to illustrate the technical solutions of the present disclosure, but not to limit the same. Although the present disclosure has been described in detail with reference to the above embodiments, those skilled in the art should understand that the technical solutions described in the above embodiments of the present disclosure may still be modified, or some or all of the technical features may be equivalently replaced. These modifications or substitutions do not make the essence of the corresponding technical solutions depart from the scope of the technical solutions in the embodiments of the present disclosure.

What is claimed is:

1. A display panel, comprising:
a pixel circuit, comprising a driving module and a bias adjustment module, wherein the bias adjustment module has a control terminal electrically connected to a first scan line, a first terminal electrically connected to a bias signal line, and a second terminal electrically connected to a first terminal of the driving module, the first scan line provides a first scanning signal, and the bias signal line provides a bias voltage;
wherein the display panel has a first frequency, a driving cycle at the first frequency comprises a writing frame and a plurality of holding frames, and the writing frame and each of the holding frames comprise at least one light-emitting cycle, respectively;
wherein within the light-emitting cycle, a total duration of at least one active level of the first scanning signal is a first duration; and
wherein at the first frequency, first durations corresponding to at least some of the plurality of holding frames are different from a first duration corresponding to the writing frame, and/or bias voltages corresponding to at least some of the plurality of holding frames are different from a bias voltage corresponding to the writing frame.

2. The display panel according to claim 1, wherein the first durations corresponding to at least some of the plurality of holding frames are greater than the first duration corresponding to the writing frame.

3. The display panel according to claim 2, wherein the plurality of holding frames comprise a first holding frame and a second holding frame, the first holding frame is located between the writing frame and the second holding frame, and a first duration corresponding to the second holding frame is greater than a first duration corresponding to the first holding frame.

4. The display panel according to claim 2, wherein a duration of the active level in the first scanning signal is a second duration; and
second durations corresponding to at least some of the plurality of holding frames are greater than a second duration corresponding to the writing frame.

5. The display panel according to claim 4, wherein second durations corresponding to at least some continuous ones of the plurality of holding frames increase gradually; or
wherein the driving cycle comprises a first holding period and a second holding period, the first holding period is located between the writing frame and the second holding period, the first holding period and the second holding period comprise at least two of the holding frames, respectively, second durations corresponding to the first holding period are equal, second durations corresponding to the second holding period are equal, and the second durations corresponding to the second holding period are greater than the second durations corresponding to the first holding period.

6. The display panel according to claim 5, wherein a difference between second durations corresponding to at least some of adjacent holding frames is Δt, and 2H≤Δt≤8H;
wherein
$$H = \frac{1}{f \times n} ,$$
f represents a basic frequency of the display panel, and n represents the number of rows of pixel circuits in the display panel.

7. The display panel according to claim 2, wherein in the light-emitting cycle, the number of the at least one active level in the first scanning signal is a first quantity; and
first quantities corresponding to at least some of the plurality of holding frames are greater than a first quantity corresponding to the writing frame.

8. The display panel according to claim 1, wherein at a first gray level of the first frequency, the bias voltages corresponding to at least some of the plurality of holding frames are less than the bias voltage corresponding to the writing frame, and the first gray level is less than 128.

9. The display panel according to claim 8, wherein the first gray level is less than or equal to 16.

10. The display panel according to claim 1, wherein at a second gray level of the first frequency, the bias voltages corresponding to at least some of the plurality of holding frames are greater than the bias voltage corresponding to the writing frame, and the second gray level is greater than or equal to 128.

11. The display panel according to claim 8, wherein the bias voltages corresponding to at least some continuous ones of the plurality of holding frames changes gradually; or
wherein the driving cycle comprises a first holding period and a second holding period, the first holding period is located between the writing frame and the second holding period, the first holding period and the second holding period comprise at least two of the plurality of holding frames, respectively, bias voltages corresponding to the first holding period are equal, bias voltages corresponding to the second holding period are equal, and the bias voltages corresponding to the first holding period are different from the bias voltages corresponding to the second holding period.

12. The display panel according to claim 11, wherein a difference between bias voltages corresponding to at least some of adjacent holding frames is ΔV, and 0.01 V≤|ΔV|≤0.1V.

13. The display panel according to claim 1, wherein the driving cycle comprises a first period and a second period, the first period is located between the writing frame and the second period, and the first period and the second period comprise a plurality of holding frames, respectively;
wherein first durations corresponding to the first period are equal to the first duration corresponding to the writing frame, and bias voltages corresponding to the first period are equal to the bias voltage corresponding to the writing frame; and
wherein first durations corresponding to the second period are different from the first duration corresponding to the writing frame, and/or bias voltages corresponding to the second period are different from the bias voltage corresponding to the writing frame.

14. The display panel according to claim 13, wherein the display panel further has a basic frequency and a second frequency, the basic frequency is f, the first frequency is f1, the second frequency is f2, and f>f2>f1; and
wherein the driving cycle at the first frequency comprise
$$\frac{f}{f 1} - 1$$
holding frames, the first period comprises holding frames from a first holding frame to a
$$( \frac{f}{f 2} - 1 ) - th$$
holding frame, and the second period comprises holding frames from a
$$( \frac{f}{f 2} ) - th$$
holding frame to a
$$( \frac{f}{f 1} - 1 ) - th$$
holding frame.

15. The display panel according to claim 1, wherein the first durations corresponding to at least some of the plurality of holding frames are different from the first duration corresponding to the writing frame; and
wherein the pixel circuit further comprises an anode reset module, and the anode reset module has a control terminal electrically connected to the first scan line, a first terminal electrically connected to a first reset line, and a second terminal electrically connected to a light-emitting element.

16. The display panel according to claim 1, wherein the pixel circuit further comprises an anode reset module, the anode reset module has a first terminal electrically connected to a first reset line and a second terminal electrically connected to a light-emitting element, and the first reset line provides a first reset voltage; and
first reset voltages corresponding to at least some of the plurality of holding frames are less than a first reset voltage corresponding to the writing frame.

17. The display panel according to claim 1, wherein the first frequency is less than 10 Hz.

18. A driving method of a display panel, wherein the display panel comprises a pixel circuit comprising a driving module and a bias adjustment module, the bias adjustment module has a control terminal electrically connected to a first scan line, a first terminal electrically connected to a bias signal line, and a second terminal electrically connected to a first terminal of the driving module, the first scan line provides a first scanning signal, and the bias signal line provides a bias voltage;
the display panel has a first frequency, a driving cycle at the first frequency comprises a writing frame and a plurality of holding frames, and the writing frame and each of the holding frames comprise at least one light-emitting cycle, respectively;
within the light-emitting cycle, a total duration of at least one active level of the first scanning signal is a first duration; and
wherein the driving method comprises:
at the first frequency, controlling first durations corresponding to at least some of the plurality of holding frames to be different from a first duration corresponding to the writing frame, and/or controlling bias voltages corresponding to at least some of the plurality of holding frames to be different from a bias voltage corresponding to the writing frame.

19. The driving method according to claim 18, wherein the first durations corresponding to at least some of the plurality of holding frames are greater than the first duration corresponding to the writing frame.

20. The driving method according to claim 19, wherein a duration of the active level in the first scanning signal is a second duration, and second durations corresponding to at least some of the plurality of holding frames are greater than a second duration corresponding to the writing frame; and/or,
wherein in the light-emitting cycle, the number of the at least one active level in the first scanning signal is a first quantity, and first quantities corresponding to at least some of the plurality of holding frames are greater than a first quantity corresponding to the writing frame.

21. The driving method according to claim 18, wherein at a first gray level of the first frequency, the bias voltages corresponding to at least some of the plurality of holding frames are less than the bias voltage corresponding to the writing frame, and the first gray level is less than 128; and/or
wherein at a second gray level of the first frequency, the bias voltages corresponding to at least some of the plurality of holding frames are greater than the bias voltage corresponding to the writing frame, and the second gray level is greater than or equal to 128.

22. The driving method according to claim 18, wherein the driving cycle comprises a first period and a second period, the first period is located between the writing frame and the second period, and the first period and the second period comprise a plurality of holding frames, respectively;
wherein first durations corresponding to the first period are equal to the first duration corresponding to the writing frame, and bias voltages corresponding to the first period are equal to the bias voltage corresponding to the writing frame; and
wherein first durations corresponding to the second period are different from the first duration corresponding to the writing frame, and/or bias voltages corresponding to the second period are different from the bias voltage corresponding to the writing frame.

23. The driving method according to claim 22, wherein the display panel further has a basic frequency and a second frequency, the basic frequency is f, the first frequency is f1, the second frequency is f2, and f>f2>f1; and
wherein the driving cycle comprises
$$\frac{f}{f 1} - 1$$
holding frames, wherein the first period comprises holding frames from a first holding frame to a
$$( \frac{f}{f 2} - 1 ) - th$$
holding frame, and the second period comprises holding frames from a
$$( \frac{f}{f 2} ) - th$$
holding frame to a
$$( \frac{f}{f 1} - 1 ) - th$$
holding frame.

24. A display device, comprising a display panel;
wherein the display panel comprises:
a pixel circuit, comprising a driving module and a bias adjustment module, wherein the bias adjustment module has a control terminal electrically connected to a first scan line, a first terminal electrically connected to a bias signal line, and a second terminal electrically connected to a first terminal of the driving module, the first scan line provides a first scanning signal, and the bias signal line provides a bias voltage;
wherein the display panel has a first frequency, a driving cycle at the first frequency comprises a writing frame and a plurality of holding frames, and the writing frame and each of the holding frames comprise at least one light-emitting cycle, respectively;
wherein within the light-emitting cycle, a total duration of at least one active level of the first scanning signal is a first duration; and
wherein at the first frequency, first durations corresponding to at least some of the plurality of holding frames are different from a first duration corresponding to the writing frame, and/or bias voltages corresponding to at least some of the plurality of holding frames are different from a bias voltage corresponding to the writing frame.
